(19) United States
(12) Patent Application Publication
(10) Pub. No.: US 2013/0330489 A1
(43) Pub. Date: Dec. 12, 2013

(54) TOWEL WITH WATERPROOF LINER

(71) Applicant: MELISSA MILLER, Sarasota, FL (US)

(72) Inventor: MELISSA MILLER, Sarasota, FL (US)

(21) Appl. No.: 13/489,556

(22) Filed: Jun. 6, 2012

(51) Int. Cl. B32B 3/06; B32B 5/06

(52) U.S. Cl. 428/35.2; 428/76

(57) ABSTRACT

A towel with a waterproof liner includes an absorbent main body having a pocket that is interposed between a front surface, a rear surface, a pair of opposing side edges, a bottom edge and a top edge, having a waterproof liner positioned therebetween.

A towel with waterproof liner also includes an absorbent main body having a pocket that is interposed between a front surface, a rear surface, a pair of opposing side edges, a bottom edge and a top edge. A sleeve that is in communication with the pocket is located along the rear surface for positioning a removable liner within the pocket.

### TECHNICAL FIELD

The present invention relates generally to towels, and more particularly to a towel having a waterproof liner that can be utilized in the home, or spa and cosmetology industries.

### BACKGROUND

The statements in this section merely provide background information related to the present disclosure and may not constitute prior art.

Each year, millions of men and women visit salons and spas for a variety of services. In many cases, these individuals receive haircuts, perms, color treatments, and cosmetology services such as makeup and facials, for example. During these visits, it is customary to for the salon to provide a towel that covers the client's neck, shoulders and other areas which are not receiving treatment. The purpose of the towel is to provide a comfortable means of protecting the client's clothing and skin from any hair clippings and other such items that be present during the service. In spa settings, soft towels having high thread counts and/or special monograms are used to convey an atmosphere of luxury and to provide extreme comfort to the user receiving a treatment.

However, with more prevalent use of special colorings, dyes and other harsh materials utilized in the beauty, hair care and cosmetology industries, conventional towels have become unable to provide adequate protection to the clients. As a result, many salons and spas are forced to use plastic aprons and/or smocks in order to ensure that a client's clothing does not become ruined by the chemicals and liquids used in the treatment. In this regard, the use of these aprons often precludes the ability to offer the more luxurious and comfortable salon towels, due to the towels inability to provide the same level of protection. Additionally, these specialized smocks and aprons are often bigger and more cumbersome than a towel. Perhaps, most important, these aprons are significantly more expensive to manufacture, leading to higher prices for the salon. Being larger, smocks are also more expensive to clean and/or launder, thereby adding to the business expenses of the salon.

Although there are known treatments and/or chemical sprays which can be applied to devices in order to increase their water resistance, these articles are not favored by salons as they often retain a chemical odor and/or result in the surface areas of the treated device being rough when making contact with the skin of a user. Additionally, aprons and treated materials tend to pool liquids onto their surfaces. These pools of liquid will then, oftentimes, make contact with the user by running off of the material surface, for example.

Accordingly, it would be beneficial to provide a towel with a waterproof liner that combines the protection of a salon apron with the comfort and appearance of a salon towel.

### SUMMARY OF THE INVENTION

The present invention is directed to a towel with a waterproof liner. One embodiment of the present invention can include an absorbent main body having a pocket that is interposed between a front surface, a rear surface, a pair of opposing side edges, a bottom edge and a top edge, having a waterproof liner positioned therebetween.

Another embodiment can further include a main body having a pocket that is interposed between a front surface, a rear surface, a pair of opposing side edges, a bottom edge and a top edge. The main body can include a sleeve that is in communication with the pocket for receiving and positioning a removable liner within the pocket.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a front view of a towel with waterproof liner in accordance with one embodiment of the invention.

FIG. 2 is a bottom view of a towel main body in accordance with another embodiment of the invention.

FIG. 3 is a bottom view of the towel with waterproof liner in accordance with the other embodiment of the invention.

FIG. 4 is a perspective view of the towel with waterproof liner in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

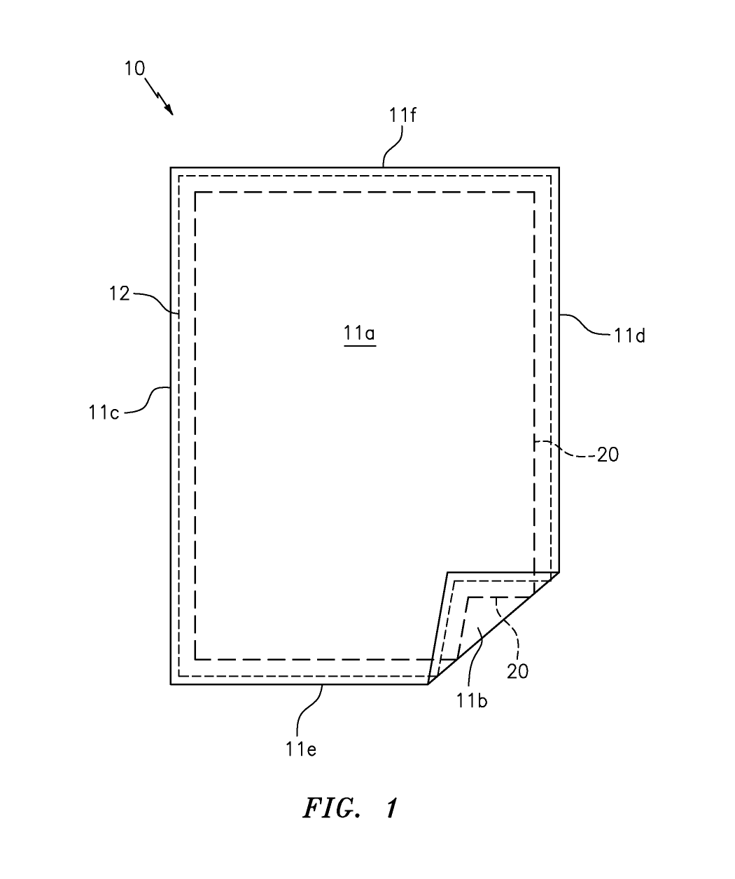

As described throughout this document, the term moisture and/or liquid can refer to any type of materials such as liquid dyes, hair chemicals, cosmetic materials, and the like from which unintended contact with a user is to be avoided. Moreover, for purposes of this description, the terms “upper,” “bottom,” “right,” “left,” “front,” “vertical,” “horizontal,” and derivatives thereof shall relate to the invention as oriented in FIG. 1.

FIG. 1 illustrates one embodiment of a towel with an integrated waterproof liner. As shown, the towel 10 can include a main body 11 and a waterproof liner 20.

The towel body 11 can include a substantially rectangular shape having a front surface 11a and a rear surface 11b. Front and rear surfaces can include substantially rectangular pieces of cloth or other such material that are joined together via a seam connector 12, such as sewed stitches, for example, along the top, bottom and opposing side edges, 11f, 11e, 11c and 11d, respectively.

The towel body 11 will preferably be constructed from a soft and absorbent material such as cotton, for example. Cotton is a common and widely accepted material for towels that are used within the hair care industry. Of course any number of other fabrics and/or materials can also be used for the towel. These other fabrics include natural materials such as wool, or synthetics such as polyester or rayon, among many others, for example.

In one preferred embodiment, the liner 20 can be constructed from a lightweight waterproof malleable material such as oilskin, for example having a shape and dimension that approximates the shape and dimensions of the towel main body 11a-11f. Of course, any number of different materials capable of repelling liquids and withstanding the rigors of commercial laundering can also be utilized herein. As described above, withstanding commercial laundering can include the ability for the towel to be sent through a conventional washing machine and dryer multiple times without diminishing the effectiveness of the water resistant and/or waterproof qualities of the liner. Several examples include plastic, vinyl cloth, rubber fabric and/or commercial products such as Gabardine® and Gore-Tex®, among many others, for example.

In one preferred embodiment, the towel 10 can include a width of approximately 17 inches (edges 11c to 11d) and a length of 23 inches (edges 11e to 11f). However, it will be apparent to those skilled in the art that the exact dimensions of the towel 10 may vary from these amounts without departing from the overall spirit and scope of the present invention.

Although described above as including a generally rectangular shaped main body with a plurality of stitches, one of skill in the art will recognize that the towel 10 can include any number of different shapes and sizes which can be formed utilizing a variety of known manufacturing techniques and seam connectors such as liquid seams, hem tape and the like, for example.

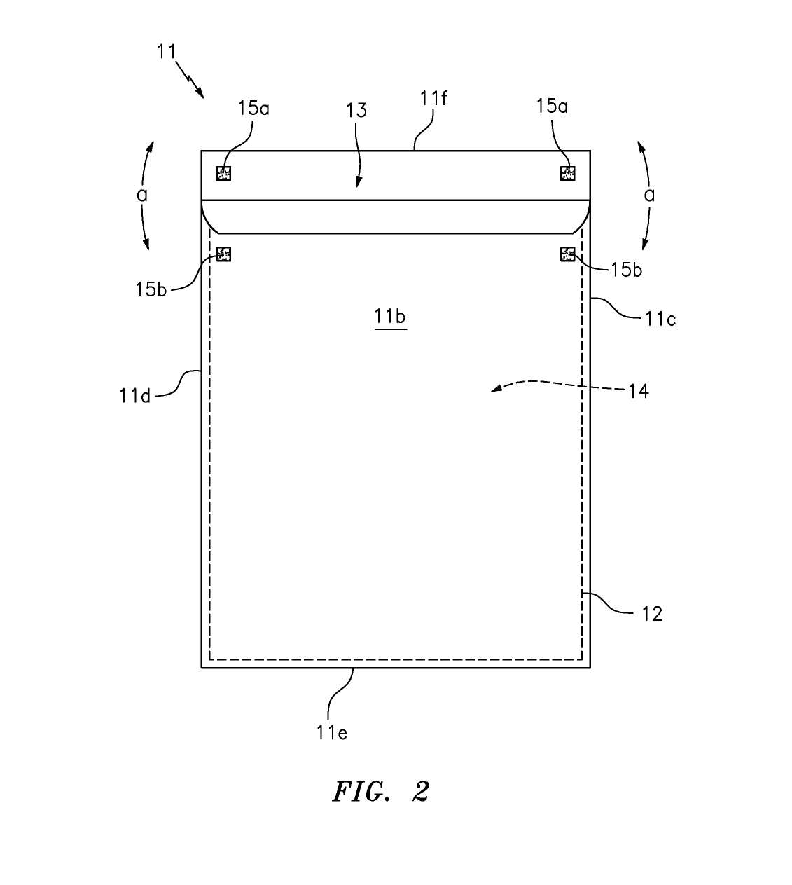

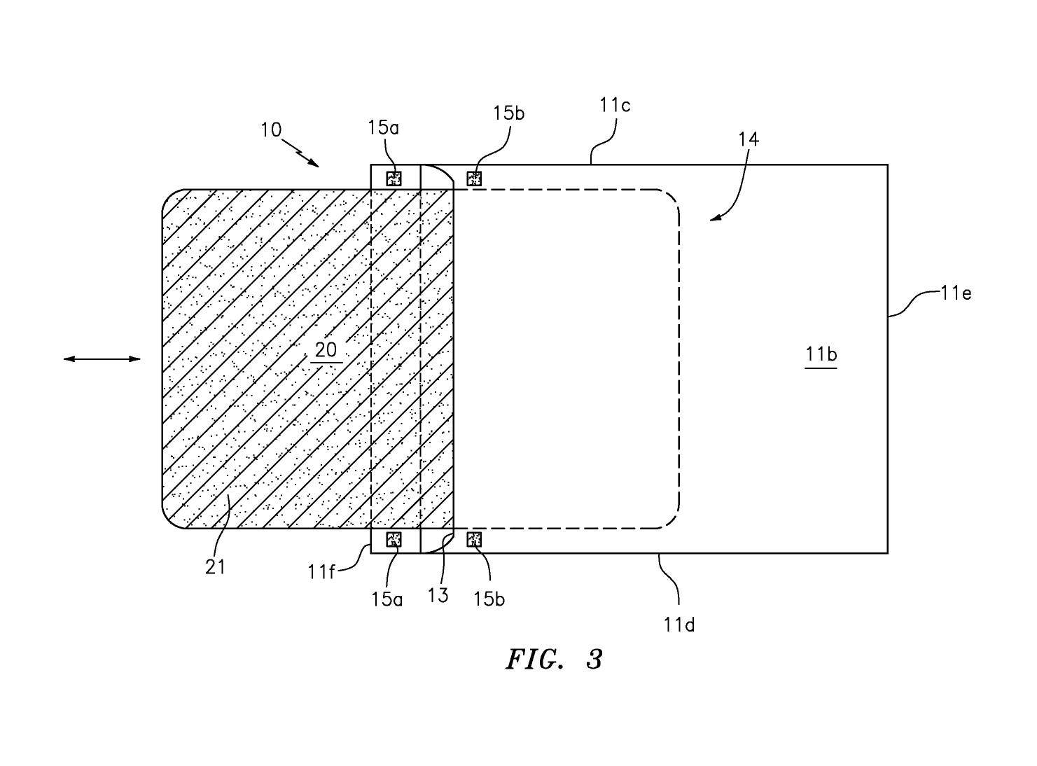

FIGS. 2 and 3 illustrate an alternate embodiment of the towel with integrated waterproof liner 10 that further includes a plurality of connectors for allowing the liner to be removably secured within the main body of the towel.

In one embodiment, the top edge 11f of the towel main body can include a sleeve 13 for accessing a pocket 14 defined by each of the body segments 11a-11e. A plurality of attachment units 15 can be secured onto the main towel body 11b in order to allow a user to selectively position the sleeve 13 into an open or closed position. In one preferred embodiment, each of the attachment units 15 can include opposing strips of hook and loop material (i.e., Velcro®) 15a and 15b that are positioned on either side of the sleeve 13. As illustrated by arrow a, each of the attachment units can be configured to selectively engage and disengage, in order to control access to the pocket 14 via the sleeve 13.

Although illustrated as the sleeve being located adjacent to the top edge, this is for illustrative purposes only, as one of skill in the art will recognize that the sleeve can be located anywhere along the top or bottom surfaces in order to allow ingress and egress of the waterproof liner. Moreover, although described above as including strips of hook and loop material, those of skill in the art will recognize that attachment units can include any number of known components capable of being removably connected. Several non-limiting examples include opposing polarity magnets and/or magnetic elements, and compression fittings such as buttons and snaps, for example. Each of these items can be permanently secured to each end of the main body 11 by a permanent sealer such as glue, adhesive tape, or stitching, for example.

Although described above as including a specific location for the one or more attachment units, other locations are also contemplated. For example, in one alternate embodiment (not illustrated), the attachment units can be located within the pocket area itself at a location adjacent to the sleeve 13 in order to removably secure surfaces 11a and 11b together.

As shown in FIG. 3, the waterproof liner 20 can be removably inserted through the sleeve 13 of the towel main body, in order to prevent liquids, chemicals and the like from transferring between surfaces 11a and 11b when positioned within the pocket 14. The liner 20 can be reusable in nature, or can be designed for a single use and then discarded.

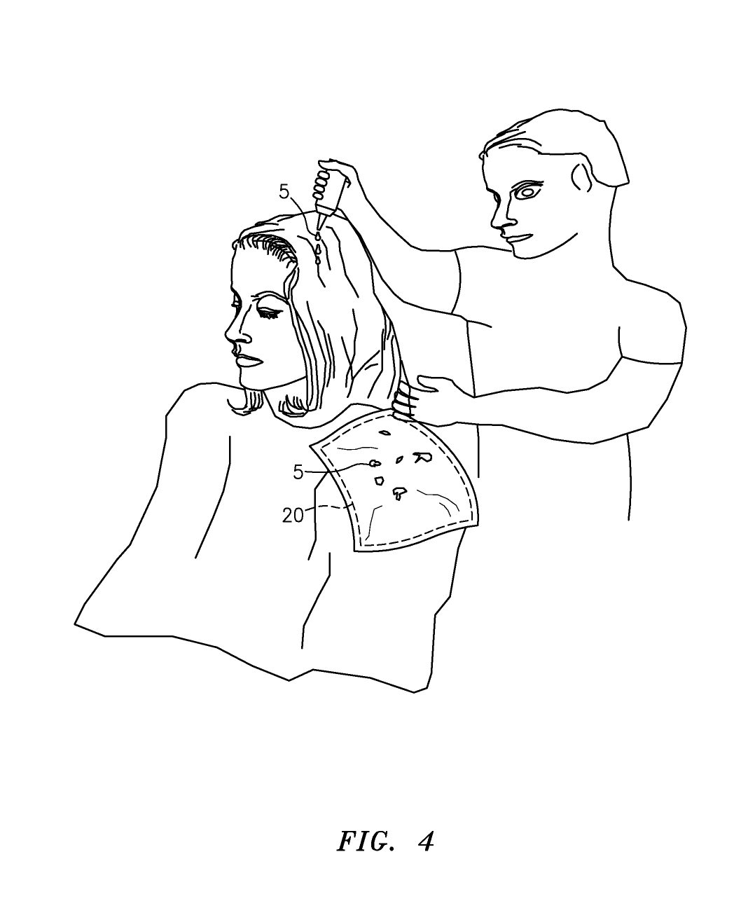

In operation, and as illustrated in FIG. 4, when liquid 5 is in contact with one of the towel body surfaces, the surface can act to absorb the liquid, thereby preventing it from pooling and running onto a client's clothing. The waterproof liner 20 can act as a barrier for preventing the liquid from reaching the other surface of the towel which is in contact with the client. To this end, the client is able to be in constant contact with the soft cloth material of the towel at all times, and can further receive the benefit of knowing that liquids will not reach them.

In one alternate embodiment, the waterproof liner 20 can include a liquid absorbent material 21 capable of absorbing moisture upon contact. The absorbing material 21 can preferably be constructed from a light mixture of wood pulp and a super absorbent material such as a plurality of polyacrylate crystals, for example, that are blended to absorb the moisture in a similar manner to a conventional diaper. Such a feature, can act to allow the material 21 and the liner 20 to absorb and pull moisture from the main towel surfaces 11a and 11b, without allowing moisture absorbed from one side to bleed through to the other side of the towel. Such a feature can act to greatly increase the usability of the towel 10 by salons where large amounts of liquids are to be utilized. Additionally, the inclusion of the absorbent material 21 can act to keep the surfaces of the towel body 11a and 11b dry, thus further enhancing the salon experience by a client.

As described herein, one or more elements of the towel with removable liner 10 can be secured together utilizing any number of known attachment means such as, for example, stitching, hem tape and/or liquid sealants, among others.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A towel with waterproof liner, comprising:
a moisture absorbing main body having a front surface, a rear surface, a top edge, a bottom edge and pair of opposing side edges, said top and bottom surfaces being joined together via a seam connector at each of the top, bottom and side edges;
a pocket interposed between the front surface, the rear surface and each of the top, bottom and side edges; and
a waterproof liner disposed within the pocket, said liner being configured to repel moisture.

2. The towel of claim 1, wherein said main body is constructed from a soft absorbent cloth material.

3. The towel of claim 1, wherein the liner is configured to prevent a transfer of moisture between the front surface and the rear surface of the main body.

4. The towel of claim 1, wherein the liner is constructed from a lightweight malleable material configured to withstand commercial laundering.

5. The towel with removable liner of claim 1, wherein the liner is constructed from an absorbent material configured to absorb moisture from each of the top and rear surfaces of the main body.

6. The towel of claim 1, wherein the seam connector includes at least one of a plurality of stitches, liquid seams, and hem tape.

7. A towel with a waterproof liner, comprising:
a main body having a pocket that is interposed between a front surface, a rear surface, a pair of opposing side edges, a bottom edge and a top edge;
a sleeve positioned along the rear surface of the main body, said sleeve being in communication with the pocket;
one or more attachment units each configured to removably position the sleeve between an open position and a closed position; and
a waterproof liner having a shape approximating a shape of the pocket, said liner being configured to be removably inserted within the pocket via the sleeve.

8. The towel of claim 7, wherein said main body is constructed from a soft absorbent cloth material.

9. The towel of claim 7, wherein the liner is constructed from a waterproof material configured to repel moisture.

10. The towel of claim 7, wherein the liner is configured to prevent a transfer of moisture between the front surface and the rear surface of the main body.

11. The towel of claim 7, wherein the liner is constructed from an absorbent material configured to absorb moisture from each of the top and rear surfaces of the main body.

12. The towel of claim 7, wherein the liner is constructed from a lightweight malleable waterproof material configured to repel moisture.

13. The towel of claim 7, wherein the liner is constructed from a disposable waterproof material configured to repel moisture.

14. The towel of claim 7, wherein each of said one or more attachment units includes at least one of a pair of opposing strips of hook and loop material, a pair of magnetic elements, and a pair of compression fittings.

15. The towel of claim 7, wherein each of the said one or more attachment units are located on the rear surface at a location adjacent to the sleeve.

16. The towel of claim 7, wherein each of the said one or more attachment units are located within the pocket at a location adjacent to the sleeve.
